(19) United States
(12) Patent Application Publication
(10) Pub. No.: US 2025/0310094 A1
(43) Pub. Date: Oct. 2, 2025

(54) ELECTRONIC DEVICE FOR PERFORMING AUTHENTICATION AND OPERATION METHOD THEREOF

(71) Applicant: Samsung Electronics Co., Ltd., Suwon-si (KR)

(72) Inventors: Geumrae BAE, Suwon-si (KR); Minjoo KIM, Suwon-si (KR); Wookwon KOO, Suwon-si (KR); Joonghwan LEE, Suwon-si (KR)

(21) Appl. No.: 19/236,258

(22) Filed: Jun. 12, 2025

Related U.S. Application Data
(63) Continuation of application No. PCT/KR2023/019711, filed on Dec. 1, 2023.

(30) Foreign Application Priority Data
Dec. 14, 2022 (KR) 10-2022-0175102

(51) Int. Cl. H04L 9/08; H04L 9/40

(52) U.S. Cl. CPC H04L 9/0869; H04L 63/0435

(57) ABSTRACT

An operation method of a first electronic device may comprise: identifying an input inputting a pincode; transmitting, to a second electronic device, the pincode and authentication information of a first electronic device, including a public key of the first electronic device; receiving encryption information from the second electronic device; identifying a first random number value on the basis of the encryption information and a private key of the first electronic device; generating a hash value based on the first random number value and the pincode; generating a datagram transport layer security (DTLS) value based on the hash value; and performing authentication with the second electronic device based on the DTLS value.

### CROSS-REFERENCE TO RELATED APPLICATIONS

This application is a continuation of International Application No. PCT/KR2023/019711 designating the United States, filed on Dec. 1, 2023, in the Korean Intellectual Property Receiving Office and claiming priority to Korean Patent Application No. 10-2022-0175102, filed on Dec. 14, 2022, in the Korean Intellectual Property Office, the disclosures of each of which are incorporated by reference herein in their entireties.

### BACKGROUND

### Field

The disclosure relates to an electronic device for performing authentication and a method for operating the same.

### Description of Related Art

As IoT technology advances, electronic devices in the home—such as smart TVs, PCs, and smart appliances—can now be interconnected. In this regard, operating systems installed on electronic devices are becoming increasingly important, as they enable a more seamless and intuitive connection between various devices to enhance the user experience.” For connectivity between electronic devices in the home, a feature may be developed that links a PC and a TV—allowing the PC's screen, as controlled by the user, to be displayed not only on the PC monitor but also on the TV.”

For connection (e.g., connection between a PC and a TV) between electronic devices, authentication between devices may be performed. For authentication between devices, a method based on whether the user's account logged in to a specific application installed in the devices matches or an account of the user using the electronic device may be used. However, authentication between devices is performed on the premise that information about the user's account is entered correctly, so authentication may be difficult if information about the user's account is lost and, if logged out, login needs to be performed again.

### SUMMARY

Embodiments of the disclosure provide a device and an operation method thereof, for performing authentication between devices and a method of operating the same without the need for inputting the user's account information to the devices.

Embodiments of the disclosure also provide a device and an operation method thereof, which may safely perform authentication by performing authentication between devices through a one-way encryption function without direct exchange of personal identification information.

A method for operating a first electronic device according to an example embodiment of the disclosure may comprise: identifying an input for entering a pincode; transmitting authentication information about the first electronic device, including a public key of the first electronic device, to a second electronic device; receiving encryption information from the second electronic device; identifying a first random value based on the encryption information and a private key of the first electronic device; generating a hash value based on the first random value and the pincode; generating a datagram transport layer security (DTLS) value based on the hash value; and performing authentication with the second electronic device based on the DTLS value.

In an example embodiment, the method for operating the first electronic device may comprise identifying a second input for selecting a device on which authentication is to be performed. In an embodiment, a device corresponding to the second input may be the second electronic device.

In an example embodiment, identifying the first random value based on the encryption information and the private key of the first electronic device may comprise: identifying information about a first function used to generate a computation value; identifying a second random value, a third random value, and the computation value based on the first function; and identifying the first random value based on the pincode, the second random value, and the computation value.

In an example embodiment, the method for operating the first electronic device may comprise: identifying a symmetric key for decrypting the first function; and identifying the first random value using the symmetric key.

In an example embodiment, the method for operating the first electronic device may comprise: identifying a second function for identifying the symmetric key; and identifying the symmetric key using the second function based on the pincode and the second random value.

In an example embodiment, generating the hash value may comprise: identifying a third function for generating the hash value; and encrypting the first random value and the pincode using the third function.

In an example embodiment, the first electronic device may be configured to generate the DTLS value using the second function based on the hash value and the third random value.

In an example embodiment, the method for operating the first electronic device may comprise: transmitting the DTLS value of the first electronic device to the second electronic device; and receiving a DTLS value of the second electronic device from the second electronic device.

In an example embodiment, the method for operating the first electronic device may comprise: determining whether the DTLS value of the first electronic device is identical to the DTLS value of the second electronic device; determining that the second electronic device is authenticated in response to determining that the DTLS value of the first electronic device is identical to the DTLS value of the second electronic device; and determining that the second electronic device is not authenticated based on determining that the DTLS value of the first electronic device and the DTLS value of the second electronic device are not identical.

In an example embodiment, the method for operating the first electronic device may comprise generating a session with the second electronic device based on determining that the second electronic device is authenticated.

In an example embodiment, the method for operating the first electronic device may comprise transmitting a success notification of authentication to the second electronic device based on determining that the second electronic device is authenticated.

A method for operating a second electronic device according to an example embodiment of the disclosure may comprise: identifying an input for entering a pincode; generating second authentication information about the second electronic device based on the pincode; receiving first authentication information including a public key of a first electronic device from the first electronic device; generating encryption information using a public key of the first electronic device; transmitting the generated encryption information to the first electronic device; generating a DTLS value based on the second authentication information and a third random value; and performing authentication with the first electronic device based on the DTLS value.

In an example embodiment, the second authentication information may include information about a first random value, a second random value, a computation value, and a hash value.

In an example embodiment, the method for operating the second electronic device may comprise generating a third random value.

In an example embodiment, the method for operating the second electronic device may comprise generating encryption information using a public key included in the first authentication information based on the second random value, the third random value, and the computation value.

In an example embodiment, the method for operating the second electronic device may comprise: generating a hash value using a first function based on the pincode and the second random value; and generating the DTLS value based on the hash value.

A first electronic device according to an example embodiment of the disclosure may comprise memory, a communication unit comprising communication circuitry, and at least one processor, comprising processing circuitry, electrically connected to the memory and the communication unit, wherein at least one processor, individually and/or collectively, may be configured to cause the first electronic device to: identify an input for entering a pincode; transmit authentication information about the first electronic device including a public key of the first electronic device to the second electronic device; receive encryption information from a second electronic device; identify a first random value based on the encryption information and a private key of the first electronic device; generate a hash value based on the first random value and the pincode; generate a datagram transport layer security (DTLS) value based on the hash value; and perform authentication with the second electronic device based on the DTLS value.

In an example embodiment, at least one processor, individually and/or collectively, may be configured to cause the first electronic device to: identify a second input for selecting a device on which authentication is to be performed. In an embodiment, a device corresponding to the second input may be the second electronic device.

In an example embodiment, at least one processor, individually and/or collectively, may be configured to cause the first electronic device to: identify information about a first function used to generate a computation value; identify a second random value, a third random value, and the computation value based on the first function; and identify the first random value based on the pincode, the second random value, and the computation value.

In an example embodiment, at least one processor, individually and/or collectively, may be configured to cause the first electronic device to: identify a symmetric key for decrypting the first function; and identify the first random value using the symmetric key.

According to the examples disclosed in the disclosure, it is possible to perform device authentication without the user's account login.

It is also possible to safely perform device authentication without direct exchange of pincodes between devices.

Effects obtainable from the disclosure are not limited to the above-mentioned effects, and other effects not mentioned may be apparent to one of ordinary skill in the art from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments;

FIG. 2 is a block diagram illustrating an example configuration of a first electronic device and a second electronic device according to various embodiments;

FIG. 3 is a flowchart illustrating example operations of a second electronic device according to various embodiments;

FIG. 4 is a signal flow diagram illustrating example operations of a first electronic device and a second electronic device according to various embodiments;

FIG. 5 is a flowchart illustrating example operations of a first electronic device according to various embodiments; and

FIG. 6 is a flowchart illustrating example operations of a second electronic device according to various embodiments.

In connection with the description of the drawings, the same or similar reference numerals may be used to denote the same or similar elements.

### DETAILED DESCRIPTION

Hereinafter, various example embodiments of the present disclosure are described in greater detail with reference to the accompanying drawings. However, it should be appreciated that the present disclosure is not limited to the example embodiments, and all changes and/or equivalents or replacements thereto also belong to the scope of the present disclosure. In the following description, the same/similar reference numerals are used to denote substantially the same components, and no duplicate description may be provided.

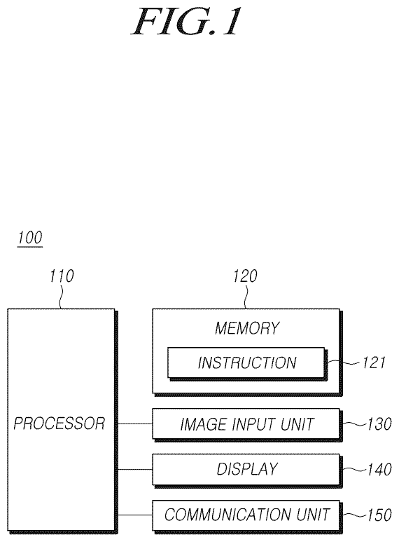

FIG. 1 is a block diagram illustrating an example configuration of an electronic device according to various embodiments. The electronic device of FIG. 1 may include, but is not limited to, a smartphone, a tablet PC, a PC, a smart TV, a mobile phone, a personal digital assistant (PDA), a laptop computer, a media player, a micro server, a digital broadcast terminal, a navigation, a kiosk, a home appliance, or other mobile or non-mobile computing devices. The electronic device 100 may perform various computing functions, such as real-time video viewing and communication. In the following description, it is assumed that the electronic device 100 is a TV or a monitor, but this is merely an example and example embodiments of the disclosure may be equally applied to electronic devices having a display function.

FIG. 1 is a block diagram illustrating an example configuration of an electronic device according to various embodiments.

According to an embodiment, the electronic device 100 may include a processor (e.g., including processing circuitry) 110, memory 120, an image input unit (e.g., including various circuitry) 130, a display 140, and a communication unit (e.g., including communication circuitry) 150.

According to an embodiment, the memory 120 may include a storage medium used by the electronic device 100, and may store data such as at least one instruction 121 or setting information corresponding to at least one program. The program may include an operating system (OS) program and various application programs.

The memory 120 may include at least one type of storage medium of flash memory types, hard disk types, multimedia card micro types, card types of memories (e.g., SD or XD memory cards), random access memories (RAMs), static random access memories (SRAMs), read-only memories (ROMs), electrically erasable programmable read-only memories (EEPROMs), programmable read-only memories (PROMs), magnetic memories, magnetic disks, or optical discs.

According to an embodiment, the image input unit 130 may include various circuitry and receive video data through a tuner (not shown), an input/output unit (not shown), or the communication unit 150. The image input unit 130 may include at least one of the tuner and the input/output unit (e.g., including input/output circuitry). The tuner may tune and select the frequency of the broadcast channel to be received by the electronic device 100 among many radio components, by amplifying, mixing, and resonating the broadcast signals wiredly/wirelessly received. The broadcast signal may include video, audio, and additional data (e.g., electronic program guide (EPG)). The tuner may receive broadcast channels (or viewing images) from various broadcast sources, such as terrestrial broadcasts, cable broadcasts, satellite broadcasts, Internet broadcasts, and the like. The tuner may be implemented integrally with the electronic device 100 or may be implemented as a separate tuner electrically connected to the electronic device 100. The input/output unit may include at least one of a high definition multimedia interface (HDMI) input port, a component input jack, a PC input port, and a USB input jack capable of receiving video data from an external device of the electronic device 100 under the control of the processor 110. It will be apparent to one of ordinary skill in the art that the input/output unit may be added, deleted, and/or changed according to the performance and structure of the electronic device 100.

According to an embodiment, the display 140 may perform functions for outputting information in the form of numbers, characters, images, and/or graphics. The display 140 may include at least one hardware module for outputting. The at least one hardware module may include, for example, and without limitation, at least one of, e.g., a liquid crystal display (LCD), a light emitting diode (LED), a light emitting polymer display (LPD), an organic light emitting diode (OLED), an active matrix organic light emitting diode (AMOLED), a flexible LED (FLED), or the like. The display 140 may display a screen corresponding to data received from the processor 110. The display 140 may be referred to as an ‘output unit’, a ‘display unit’, or by other terms having an equivalent technical meaning.

According to an embodiment, the communication unit 150 may include various communication circuitry and provide a wired/wireless communication interface enabling communication with an external device. The communication unit 150 may include at least one of a wired Ethernet, a wireless LAN communication unit, and a short-range communication unit. The wireless LAN communication unit may include, e.g., Wi-Fi, and may support the wireless LAN standard (IEEE802.11x) of the institute of electrical and electronics engineers (IEEE). The wireless LAN communication unit may be wirelessly connected to an access point (AP) under the control of the processor 110. The short-range communication unit may perform short-range communication wirelessly with an external device under the control of the processor 110. Short-range communication may include Bluetooth, Bluetooth low energy, infrared data association (IrDA), ultra-wideband (UWB), and near-field communication (NFC). The external device may include a server device and a mobile terminal (e.g., phone, tablet, etc.) providing, e.g., a video service.

According to an embodiment, the processor 110 may include various processing circuitry and control at least one other component of the electronic device 100 and/or execute computation or data processing regarding communication by executing at least one command 121 stored in the memory 120. The processor 110 may include at least one of a central processing unit (CPU), a graphic processing unit (GPU), a micro controller unit (MCU), a sensor hub, a supplementary processor, a communication processor, an application processor, an application specific integrated circuit (ASIC), field programmable gate arrays (FPGA), or the like, and may have multiple cores. Thus, the processor 110 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

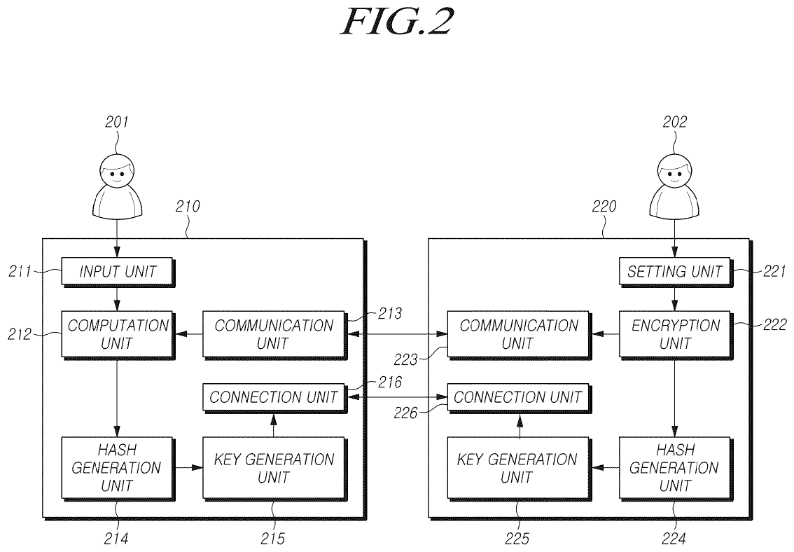

FIG. 2 is a block diagram illustrating an example configuration of a first electronic device and a second electronic device according to various embodiments. The first electronic device and the second electronic device illustrated in FIG. 2 may be devices corresponding to the electronic device 100 of FIG. 1. In the following description, an example is described in which the first electronic device is a PC, and the second electronic device is a TV, but this is merely an example, and the electronic devices according to embodiments of the disclosure may include other types of electronic devices (e.g., monitors, smart refrigerators, smart washers, smart air purifiers, or the like).

The first electronic device 210 according to an embodiment may include an input unit (e.g., including input circuitry) 211, a computation unit (e.g., including various circuitry and/or executable program instructions) 212, a communication unit (e.g., including communication circuitry) 213, a hash generation unit (e.g., including various circuitry and/or executable program instructions) 214, a key generation unit (e.g., including various circuitry and/or executable program instructions) 215, and a connection unit (e.g., including various circuitry) 216.

The second electronic device 220 according to an embodiment may include a setting unit (e.g., including various circuitry and/or executable program instructions) 221, an encryption unit (e.g., including various circuitry and/or executable program instructions) 222, a communication unit (e.g., including communication circuitry) 223, a hash generation unit (e.g., including various circuitry and/or executable program instructions) 224, a key generation unit (e.g., including various circuitry and/or executable program instructions) 225, and a connection unit (e.g., including various circuitry) 226.

In an embodiment, the first electronic device 210 may identify an input (e.g., a user input) for entering a first pincode from a first user 201 through the input unit 211. The first pincode may refer, for example, to personal identification information input by the user. The input unit 211 may transmit the first pincode, according to the identified user input, to the computation unit 212.

In an embodiment, the computation unit 212 may identify information about a random number used by the second electronic device 220 for encryption of the second pincode, based on the first pincode received from the input unit 211 and the encryption information received from the communication unit 213. When the first pincode corresponds to the second pincode, the first electronic device 210 may accurately identify information about the random number used by the second electronic device 220 for encryption of the second pincode, but when the first pincode does not correspond to the second pincode, the first electronic device 210 may not identify information about the random number used by the second electronic device 220 for encryption of the second pincode.

In an embodiment, the first electronic device 210 may receive encryption information about the second electronic device 220 from the communication unit 223 of the second electronic device 220 through the communication unit 213.

In an embodiment, the first electronic device 210 may transmit the first authentication information to the communication unit 223 of the second electronic device 220 through the communication unit 213.

In an embodiment, the hash generation unit 214 may generate a first hash value to be used by the key generation unit 215.

In an embodiment, the key generation unit 215 may generate a first data transport layer security (DTLS) value, which may refer, for example, to a key value to be used by the first electronic device 210 for DTLS communication, based on the first hash value.

In an embodiment, the connection unit 216 of the first electronic device 210 may connect the first electronic device 210 to the second electronic device 220 by generating a DTLS session with the connection unit 226 of the second electronic device 220.

In an embodiment, when the first DTLS value is identical to the second DTLS value received from the second electronic device 220, the first electronic device 210 may determine that authentication of the first electronic device 210 and the second electronic device 220 has succeeded.

In an embodiment, the second electronic device 220 may identify an input (e.g., the user's input) for setting a pincode from the second user 202 through the setting unit 221. The pincode identified in the user input identified from the second user may refer, for example, to personal identification information input by the user to be used for authentication between devices.

In an embodiment, the setting unit 221 may transmit the pincode identified from the second user 202 to the encryption unit 222.

In an embodiment, the encryption unit 222 may generate encryption information by encrypting the pincode received from the setting unit 221. The encryption unit 222 may generate encryption information using random values.

In an embodiment, the encryption unit 222 may transmit the generated encryption information to the communication unit 223.

In an embodiment, the communication unit 223 may transmit the encryption information received from the encryption unit 222 to the communication unit 213 of the second electronic device 220.

In an embodiment, the hash generation unit 224 may generate a second hash value to be used by the key generation unit 225.

In an embodiment, the key generation unit 225 may generate a second DTLS value, indicating a key value to be used by the second electronic device 220 for DTLS communication, based on the second hash value.

In an embodiment, the connection unit 226 of the second electronic device 220 may generate a DTLS session with the connection unit 216 of the first electronic device 210 to connect the first electronic device 210 to the second electronic device 220.

In an embodiment, when the second DTLS value is identical to the first DTLS value received from the first electronic device 210, the second electronic device 220 may determine that authentication of the first electronic device 210 and the second electronic device 220 is successful.

In an embodiment, although not illustrated in the drawings, the first electronic device 210 may include a first pre-processing unit (not illustrated) for generating first authentication information indicating authentication information about the first electronic device 210.

In an embodiment, the first authentication information may include information about a public key of the first electronic device 210 and information about a private key. The first electronic device 210 may generate the public key and the private key as a pair.

In an embodiment, the first authentication information may include device information (e.g., type of device, manufacturer of device, device identification information, etc.) about the first electronic device 210.

In an embodiment, the second authentication information may include device information (e.g., type of device, manufacturer of device, device identification information, etc.)

about the second electronic device 220.

In an embodiment, the second authentication information may include information about the second pincode, the first random value, the second random value, the first hash value, and the computation value input to the second electronic device.

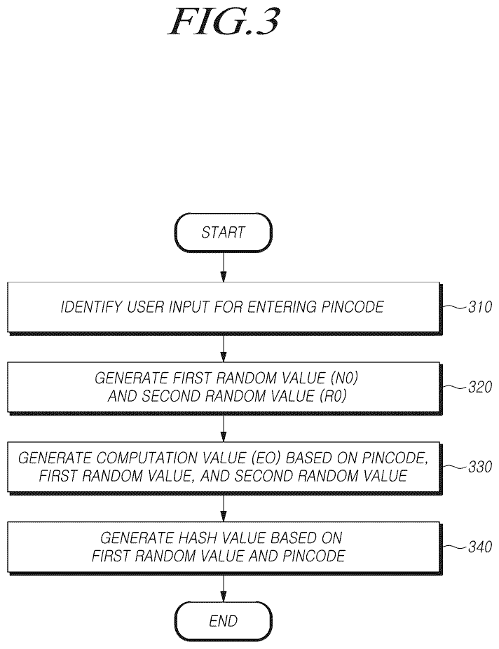

FIG. 3 is a flowchart illustrating example operations of a second electronic device according to various embodiments. The second electronic device illustrated in FIG. 3 may represent the second electronic device 220 of FIG. 2. The operation of the second electronic device 220 described in connection with FIG. 3 may include an operation of the second electronic device 220 to generate the second hash value generated through the hash generation unit 224 and encryption information generated through the encryption unit 222.

According to an embodiment, in operation 310, the second electronic device may identify an input (e.g., a user input) for entering the second pincode. The second pincode may refer, for example, to personal identification information set by the user.

According to an embodiment, in operation 320, the second electronic device may generate a first random value NO and a second random value R0. The second electronic device may use a predetermined (e.g., specified) function or algorithm to generate a random value. The first random value and the second random value may refer, for example, to an arbitrary number randomly generated by the second electronic device.

According to an embodiment, in operation 330, the second electronic device may generate a computation value E0 based on the second pincode, the first random value N0, and the second random value R0.

In an embodiment, the computation value may refer, for example, to a value encrypted through another specific function (e.g., AES256) using a symmetric key value derived through a specific function (e.g., password based key derivation function2 (PBKDF2)) from the second pincode. For example, the second electronic device may generate a symmetric key using PBKDF2 using the second random value and the second pincode. The second electronic device may generate a computation value E0 by encrypting the first random value in the AES256 method using the symmetric key.

According to an embodiment, in operation 340, the second electronic device may generate a second hash value based on the first random value and the second pincode.

In an embodiment, the second hash value may refer, for example, to a value generated using a specific method such as SHA256 based on the first random value and the second pincode.

In an embodiment, the generated first random value, second random value, computation value, second pincode, and second hash value may be stored in the memory. As described above, the information stored in the memory may be used for authentication with the first electronic device.

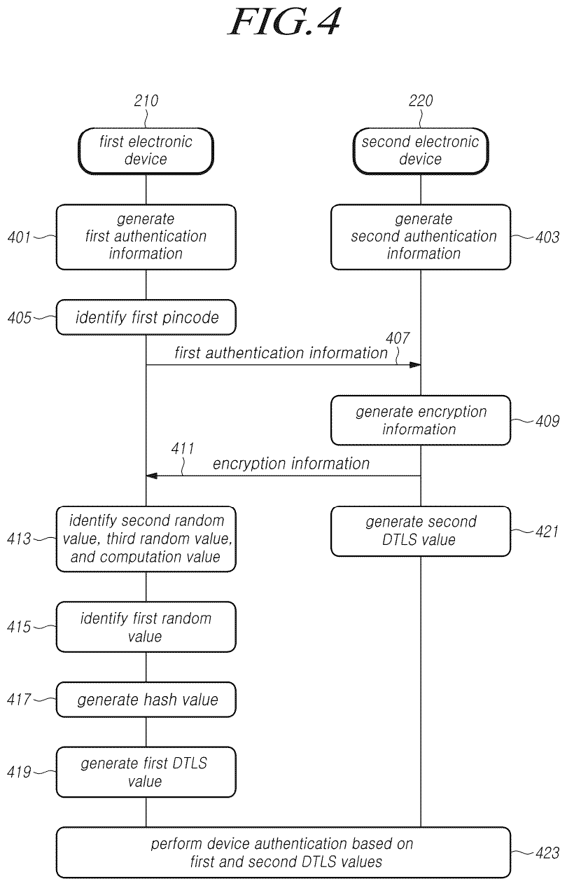

FIG. 4 is a signal flow diagram illustrating example operations of a first electronic device and a second electronic device according to various embodiments.

According to an embodiment, in operation 401, the first electronic device 210 may generate first authentication information.

In an embodiment, the first authentication information may include device information about the first electronic device 210 and information about the private key-public key pair of the first electronic device 210.

According to an embodiment, in operation 403, the second electronic device 220 may generate second authentication information.

In an embodiment, the second authentication information may include information about the second pincode, the first random value, the second random value, the first hash value, and the computation value input to the second electronic device.

According to an embodiment, in operation 405, the first electronic device 210 may identify the first pincode.

In an embodiment, the first electronic device 210 may identify a user input for entering the first pincode. The first pincode may refer, for example, to a code such as a password that the user enters into the first electronic device 210 for authentication.

According to an embodiment, in operation 407, the first electronic device 210 may transmit the first authentication information to the second electronic device 220.

According to an embodiment, in operation 409, the second electronic device 220 may generate encryption information.

In an embodiment, the second electronic device 220 may determine whether to generate encryption information based on the device information about the first electronic device 210 included in the first authentication information received from the first electronic device 210. For example, when it is determined that the manufacturer of the device included in the first authentication information matches the manufacturer of the second electronic device 220, it may be determined that the encryption information is to be generated. The operation of determining whether to generate the encryption information about the second electronic device 220 may be omitted in some cases.

In an embodiment, the second electronic device 220 may generate encryption information based on the public key of the first electronic device 210 included in the first authentication information received from the first electronic device 210. The second electronic device 220 may generate a third random value different from the first random value and the second random value generated in operation 403.

In an embodiment, the second electronic device 220 may generate encryption information by encrypting the third random value, the computation value, and the second random value using the public key of the first electronic device 210 obtained through the first authentication information.

According to an embodiment, in operation 411, the second electronic device 220 may transmit the encryption information to the first electronic device 210.

According to an embodiment, in operation 413, the first electronic device 210 may identify the second random value, the third random value, and the computation value based on the received encryption information.

According to an embodiment, in operation 415, the first electronic device 210 may identify the first random value by decrypting the computation value.

In an embodiment, the first electronic device 210 may identify the symmetric key using a specific function based on the first pincode and the second random value. The first electronic device 210 may identify the first random value by decrypting the computation value using the symmetric key.

According to an embodiment, in operation 417, the first electronic device 210 may generate a first hash value.

In an embodiment, the first electronic device 210 may generate a first hash value by encrypting the first random value and the first pincode through the SHA256 method.

According to an embodiment, in operation 419, the first electronic device 210 may generate the first DTLS value using PBKDF2 with the first hash value as a key and using the third random value.

According to an embodiment, in operation 421, the second electronic device 220 may generate the second DTLS value using PBKDF2 using the second hash value and the third random value.

According to an embodiment, in operation 423, the first electronic device 210 and the second electronic device 220 may perform mutual authentication based on the first DTLS value and the second DTLS value.

In an embodiment, the first electronic device 210 may transmit the first DTLS value to the second electronic device 220, and the second electronic device 220 may transmit the second DTLS value to the first electronic device 210. When the first DTLS value is identical to the second DTLS value received from the second electronic device 220, the first electronic device 210 may determine that authentication has succeeded. When the second DTLS value is identical to the first DTLS value received from the first electronic device 210, the second electronic device 220 may determine that authentication has succeeded.

Specific functions such as SHA256, AES256, and PDKDF2 described above are merely examples and may be replaced by other algorithms performing similar operations.

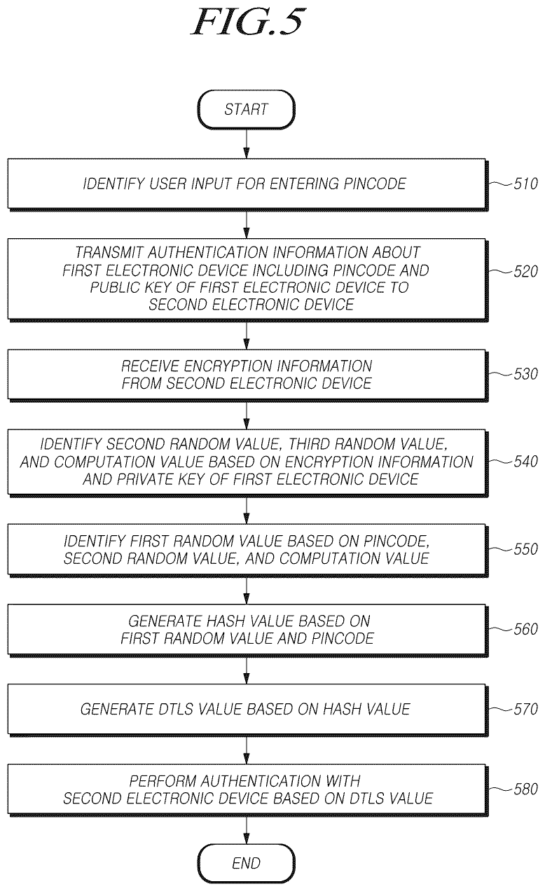

FIG. 5 is a flowchart illustrating example operations of a first electronic device according to various embodiments. The first electronic device of FIG. 5 may refer, for example, to the first electronic device 210, and the second electronic device may refer, for example, to the second electronic device 220. Operations of the first electronic device 210 and the second electronic device 220 described in connection with FIG. 5 may include operations included in an example of signaling of the first electronic device 210 and the second electronic device 220 described in connection with FIG. 4.

According to an embodiment, in operation 510, the first electronic device may identify a user input for entering a pincode. The pincode may refer, for example, to personal identification information input by the user for authentication.

In an embodiment, the first electronic device may identify a second user input for selecting a device on which authentication is to be performed. The device corresponding to the second user input may be the second electronic device.

According to an embodiment, in operation 520, the first electronic device may transmit authentication information about the first electronic device including the pincode and the public key of the first electronic device to the second electronic device.

In an embodiment, the first authentication information may include information about a private key of the first electronic device.

According to an embodiment, in operation 530, the first electronic device may receive encryption information from the second electronic device.

According to an embodiment, in operation 540, the first electronic device may identify the second random value, the third random value, and the computation value based on encryption information and the private key of the first electronic device.

In an embodiment, the first electronic device may identify information about the first function used to generate the computation value. For example, the first function may refer, for example, to an AES256 function. For example, the first electronic device may receive information about the first function from the second electronic device.

According to an embodiment, in operation 550, the first electronic device may identify the first random value based on the pincode, the second random value, and the computation value.

In an embodiment, the first electronic device may identify a symmetric key for decrypting the first function. The first electronic device may identify the first random value using the symmetric key. The first electronic device may identify a second function for identifying the symmetric key. For example, the second function may include a Pbkdf2 function. The first electronic device may identify the symmetric key using the second function based on the first pincode and the second random value. The first electronic device may receive information about the second function from the second electronic device.

According to an embodiment, in operation 560, the first electronic device may generate a hash value based on the first random value and the pincode.

In an embodiment, the first electronic device may identify a third function for generating a hash value. The first electronic device may encrypt the first random value and the pincode using the third function. For example, the third function may be an SHA256 function. The first electronic device may receive information about the third function from the second electronic device.

According to an embodiment, in operation 570, the first electronic device may generate a DTLS value based on the hash value.

In an embodiment, the first electronic device may generate the DTLS value using the second function based on the hash value and the third random value.

According to an embodiment, in operation 580, the first electronic device may perform authentication with the second electronic device based on the DTLS value.

In an embodiment, the first electronic device may transmit the DTLS value of the first electronic device to the second electronic device. The first electronic device may receive the DTLS value of the second electronic device from the second electronic device.

In an embodiment, the first electronic device may determine whether the DTLS value of the first electronic device is identical to the DTLS value of the second electronic device. When the first electronic device determines that the DTLS value of the first electronic device is identical to the DTLS value of the second electronic device, the first electronic device may determine that the second electronic device is authenticated. When the first electronic device determines that the DTLS value of the first electronic device is not identical to the DTLS value of the second electronic device, the first electronic device may determine that the second electronic device is not authenticated.

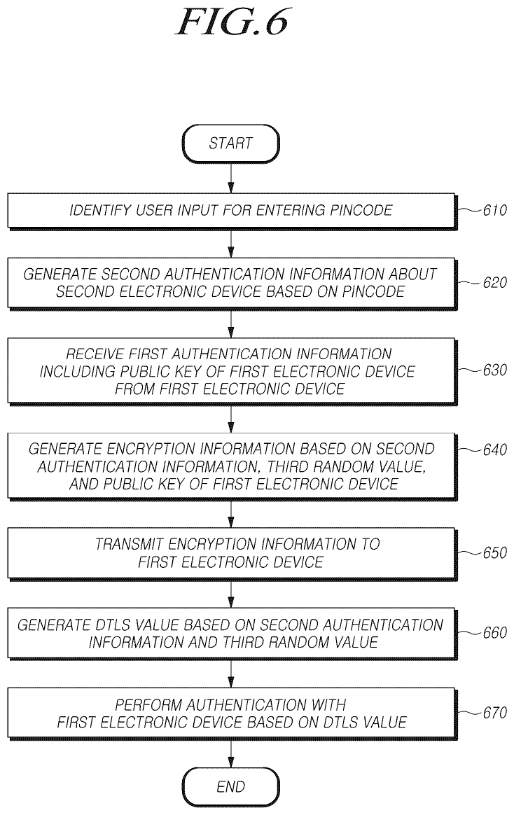

FIG. 6 is a flowchart illustrating example operations of a second electronic device according to various embodiments. The second electronic device of FIG. 6 may refer, for example, to the second electronic device 220 of FIG. 4. The first electronic device of FIG. 6 may refer, for example, to the first electronic device 210 of FIG. 4. The operation of the second electronic device of FIG. 6 may include the operation of the second electronic device 220 of FIG. 4.

According to an embodiment, in operation 610, the second electronic device may identify a user input for entering a pincode. According to an embodiment, in operation 620, the second electronic device may generate second authentication information about the second electronic device based on the pincode. Operations 610 and 620 may include operations 310, 320, and 330 of the second electronic device of FIG. 3.

According to an embodiment, in operation 630, the second electronic device may receive first authentication information including the public key of the first electronic device from the first electronic device.

According to an embodiment, in operation 640, the second electronic device may generate encryption information based on the second authentication information, the third random value, and the public key of the first electronic device.

In an embodiment, the second authentication information may include information about the first random value, the second random value, the computation value, and the hash value.

According to an embodiment, the second electronic device may generate a third random value.

According to an embodiment, in operation 650, the second electronic device may transmit encryption information to the first electronic device.

In an embodiment, the second electronic device may comprise generating encryption information using the public key included in the first authentication information based on the second random value, the third random value, and the computation value.

According to an embodiment, in operation 660, the second electronic device may generate a DTLS value based on the second authentication information and the third random value.

In an embodiment, the second electronic device may generate a hash value using the first function based on the pincode and the second random value. The second electronic device may generate the DTLS value based on the hash value.

According to an embodiment, in operation 670, the second electronic device may perform authentication with the first electronic device based on the DTLS value.

In an embodiment, the second electronic device may transmit the DTLS value of the second electronic device to the first electronic device. The second electronic device may receive the DTLS value of the first electronic device from the first electronic device.

In an embodiment, the second electronic device may determine whether the DTLS value of the second electronic device is identical to the DTLS value of the first electronic device. When the second electronic device determines that the DTLS value of the second electronic device is identical to the DTLS value of the first electronic device, the second electronic device may determine that the first electronic device is authenticated. When the second electronic device determines that the DTLS value of the second electronic device is not identical to the DTLS value of the first electronic device, the second electronic device may determine that the first electronic device is not authenticated.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, or any combination thereof, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the server device 200 described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A method for operating a first electronic device, comprising:
identifying an input for entering a pincode;
transmitting authentication information about the first electronic device, including a public key of the first electronic device, to a second electronic device;
receiving encryption information from the second electronic device;
identifying a first random value based on the encryption information and a private key of the first electronic device;
generating a hash value based on the first random value and the pincode;
generating a datagram transport layer security (DTLS) value based on the hash value; and
performing authentication with the second electronic device based on the DTLS value.

2. The method of claim 1, further comprising identifying a second input for selecting a device on which authentication is to be performed,
wherein the second electronic device comprises a device corresponding to the second input.

3. The method of claim 1, wherein the identifying the first random value based on the encryption information and the private key of the first electronic device comprises:
identifying a second random value, a third random value, and a computation value based on the encryption information and the private key of the first electronic device;
identifying information about a first function used to generate the computation value; and
identifying the first random value based on the pincode, the second random value, and the computation value.

4. The method of claim 3, wherein the identifying the first random value based on the pincode, the second random value, the information about the first function, and the computation value comprises:
identifying a symmetric key for the first function based on the pincode and the second random value; and
identifying the first random value using the symmetric key.

5. The method of claim 4, wherein the identifying the symmetric key for the first function based on the pincode and the second random value comprises:
identifying a second function for identifying the symmetric key; and
identifying the symmetric key using the second function based on the pincode and the second random value.

6. The method of claim 5, wherein the generating the hash value based on the first random value and the pincode comprises:
identifying a third function for generating the hash value; and
generating the hash value by encrypting the first random value and the pincode using the third function.

7. The method of claim 6, wherein the generating the DTLS value based on the hash value comprises generating the DTLS value using the second function based on the hash value and the third random value.

8. The method of claim 1, wherein the performing authentication with the second electronic device based on the DTLS value comprises:
transmitting the DTLS value of the first electronic device to the second electronic device; and
receiving a DTLS value of the second electronic device from the second electronic device.

9. The method of claim 8, wherein the performing authentication with the second electronic device based on the DTLS value further comprises:
determining whether the DTLS value of the first electronic device and the DTLS value of the second electronic device are identical;
determining that the second electronic device is authenticated based on determining that the DTLS value of the first electronic device and the DTLS value of the second electronic device are identical; and
determining that the second electronic device is not authenticated based on determining that the DTLS value of the first electronic device and the DTLS value of the second electronic device are not identical.

10. The method of claim 9, further comprising generating a session with the second electronic device based on determining that the second electronic device is authenticated.

11. The method of claim 10, further comprising transmitting a success notification of authentication to the second electronic device based on determining that the second electronic device is authenticated.

12. A method for operating a second electronic device, the method comprising:
identifying an input for entering a pincode;
generating second authentication information about the second electronic device based on the pincode;
receiving first authentication information including a public key of a first electronic device from the first electronic device;
generating encryption information using the public key of the first electronic device;
transmitting the generated encryption information to the first electronic device;
generating a DTLS value based on the second authentication information and a third random value; and
performing authentication with the first electronic device based on the DTLS value.

13. The method of claim 12, wherein the generating the encryption information using the public key of the first electronic device comprises:
generating a computation value by encrypting a first random value with a first function using a symmetric key for the first function.

14. The method of claim 12, wherein the second authentication information includes information about a first random value, a second random value, a computation value, and a hash value.

15. The method of claim 13, wherein the generating the encryption information using the public key of the first electronic device comprises generating the encryption information by encrypting the second random value, the third random value, and the computation value using the public key.

16. The method of claim 15, wherein the generating the DTLS value based on the second authentication information and the third random value comprises:
generating a hash value using a third function based on the pincode and the first random value; and
generating the DTLS value based on the hash value.

17. A first electronic device, comprising:
memory;
a communication unit comprising communication circuitry;
at least one processor, comprising processing circuitry, electrically connected to the memory and the communication unit, wherein at least one processor, individually and/or collectively, is configured to cause the first electronic device to:
identify an input for entering a pincode;
transmit authentication information about the first electronic device, including a public key of the first electronic device, to a second electronic device;
receive encryption information generated based on the public key from the second electronic device;
identify a first random value based on the encryption information and a private key of the first electronic device;
generate a hash value based on the first random value and the pincode;
generate a datagram transport layer security (DTLS) value based on the hash value; and
perform authentication with the second electronic device based on the DTLS value.

18. The first electronic device of claim 17, wherein at least one processor, individually and/or collectively, is configured to cause the first electronic device to:
identify a second input for selecting a device on which authentication is to be performed, and
select the second electronic device as the device on which the authentication is to be performed, based on the second input.

19. The first electronic device of claim 17, wherein at least one processor, individually and/or collectively, is configured to cause the first electronic device to:
identify information about a first function used to generate a computation value;
identify a second random value, a third random value, and the computation value based on the encryption information and the private key of the first electronic device;
identify information about a first function used to generate the computation value; and
identify the first random value based on the pincode, the second random value, the information about the first function, and the computation value.

20. The first electronic device of claim 19, wherein at least one processor, individually and/or collectively, is configured to cause the first electronic device to:
identify a symmetric key for the first function based on the pincode and the second random value; and
identify the first random value using the symmetric key.
